(19) United States
(12) Patent Application Publication
(10) Pub. No.: US 2018/0339863 A1
(43) Pub. Date: Nov. 29, 2018

(54) CONVEYOR APPARATUS

(71) Applicant: TOAN CORP., Tokyo (JP)

(72) Inventors: Shinji ISHIKAWA, Tokyo (JP); Shinya NAGASHIMA, Tokyo (JP)

(73) Assignee: Toan Corp., Tokyo (JP)

(21) Appl. No.: 15/771,933

(22) PCT Filed: Oct. 28, 2016
(86) PCT No.: PCT/JP2016/082064

§ 371 Date: Apr. 27, 2018

(30) Foreign Application Priority Data
Nov. 2, 2015 (JP) 2015-215736

(51) Int. Cl. B65G 35/06; B62D 65/18; B61B 13/06; B65G 1/04

(52) U.S. Cl. CPC B65G 35/063; B65G 1/0492; B61B 13/06; B62D 65/18

(57) ABSTRACT

A conveyor apparatus for conveying a moving body along a conveyance path, the conveyor apparatus comprising: a frame body to which a pair of roller members that rolls along the conveyance path are attached; a pair of guide rails on which the roller members travel; cables for connecting various devices; and a support member having a support surface to support the cables, wherein each of the guide rails comprises: a traveling portion on which the roller members travel, and a side wall portion extending from the traveling portion, wherein the side wall portion of one of the guide rails and the side wall portion of the other one of the guide rails are arranged separately from each other, and wherein the cables are housed in a space defined by the support surface and the respective side wall portions.

### TECHNICAL FIELD

The present invention relates to a conveyor apparatus. In particular, the present invention relates to a conveyor apparatus having a small dimension in its height direction and being capable of housing cables, thus achieving space saving.

### BACKGROUND OF THE INVENTION

Conveyor apparatuses for conveying various articles to be transferred have been developed so far. One example is a conveyor apparatus used for conveying various parts such as a car body in an automobile plant. In many cases, articles to be transferred are placed on a moving body (carriage) traveling along a specified conveyance path. Conveyor apparatus conveys articles to be transferred by conveying the moving body.

In order to convey articles to be transferred, an actuator such as a motor, various control units, cables for connection thereof and the like are attached to a conveyor apparatus. However, especially cables occupy a large space. Thus, in Patent Document 1, a wiring structure in which cables are housed in a conveyor apparatus by providing yokes having a U-shaped cross-section and an opening in an upward direction is disclosed. FIG. 5 shows a schematic cross-sectional view of the conveyor apparatus 1a described in Patent Document 1.

In the conveyor apparatus 1a described in Patent Document 1, a space Sa is provided under roller members 3a by providing a yoke Y to house cables (not shown) therein. However, in such a conveyor apparatus 1a, a dimension in its height direction is large and space saving cannot be achieved sufficiently. In FIG. 5, a reference symbol H2 indicates an example of a height of a working platform when various works are conducted in the conveyor apparatus 1a. Further, for example, in various steps (for example, a coating step, an assembling step and the like) for manufacturing automobiles, it is desirable that portions not relating to manufacturing works are covered to avoid staining and damaging thereof. In the conveyor apparatus 1a described in Patent Document 1, since a dimension in its height direction is large, a volume of the portion to be covered in various steps is large, and convenience in working is not so good.

Thus, a conveyor apparatus in which a yoke was eliminated and a dimension in a height direction was decreased was proposed. FIG. 6 shows a schematic cross-sectional view of a conventional conveyor apparatus 1b in which a yoke was eliminated. In FIG. 6, a reference symbol H3 indicates an example of a height of a working platform when various works are conducted in the conveyor apparatus 1b. The height H3 is designed so as to be significantly lower than the height H2 (see FIG. 5). Therefore, a volume of portions to be covered in various steps is small and convenience in working is good. However, in such a conveyor apparatus 1b, cables cannot be housed in the apparatus. Therefore, cables must be disposed along a conveyance path, and a duct for passing cables along rails is required separately. As a result in the conveyor apparatus 1b shown in FIG. 6, a large space is occupied therefor.

### Patent Document

Patent Document 1: JP 2006-8097 A

### SUMMARY OF THE INVENTION

An object of the present invention is to provide a conveyor apparatus which has a small dimension in its height direction, is capable of housing cables therein and enables space saving to be achieved unlike conventional conveyor apparatuses.

The conveyor apparatus according to one aspect of the present invention for solving the above-mentioned problem is a conveyor apparatus for conveying, along a specified conveyance path, a moving body on which an article to be transferred is placed, and comprises a pair of roller members that rolls along the conveyance path, a frame body to which the pair of roller members are attached, a pair of guide rails on which the roller members travel, cables for connecting various devices associated with operation of the conveyor apparatus, and a support member having a support surface to support the cables, wherein each of the guide rails comprises a traveling portion on which the roller member travels, and a side wall portion extending substantially in a vertical direction from the traveling portion and being disposed at an inner part of a travelling position of the roller member, wherein the side wall portion of one of the guide rails and the side wall portion of the other one of the guide rails are arranged separately from each other, and wherein the cables are housed in a space defined by the support surface and the respective side wall portions.

### BRIEF DESCRIPTION OF THE DRAWINGS

FIG. 1 is a schematic cross-sectional view of a conveyor apparatus according to one embodiment of the present invention.

FIG. 2 is an enlarged schematic cross-sectional view of a conveyor apparatus according to one embodiment of the present invention.

FIG. 3 is a schematic plan view of a support frame according to one embodiment of the present invention.

FIG. 4 is a schematic plan view of a net-like body disposed along curved guide rails according to one embodiment of the present invention.

FIG. 5 is a schematic cross-sectional view of a conveyor apparatus described in Patent Document 1.

FIG. 6 is a schematic cross-sectional view of a conventional conveyor apparatus.

### MODE FOR CARRYING OUT THE INVENTION

### Conveyor Apparatus

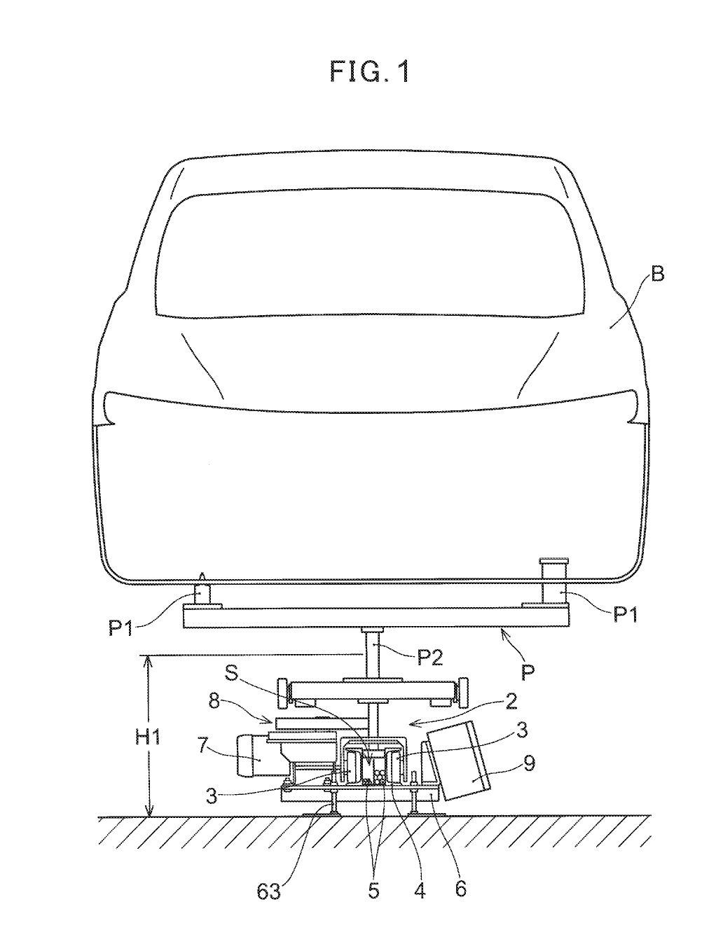

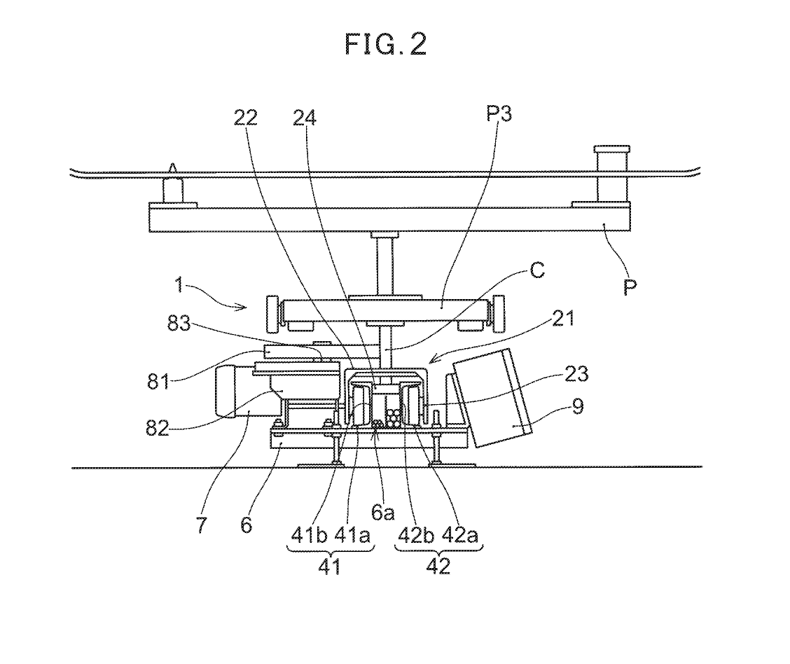

The conveyor apparatus according to one embodiment of the present invention is described below by referring to the drawings. FIG. 1 is a schematic cross-sectional view of the conveyor apparatus 1 according to this embodiment. FIG. 2 is an enlarged schematic cross-sectional view of the conveyor apparatus 1 according to this embodiment. As shown in FIG. 1, the conveyor apparatus 1 is an apparatus for conveying a carriage P (an example of a moving body), on which a body B of a car (an example of an article to be transferred) is placed, along a specified conveyance path. As shown in FIG. 2, the conveyor apparatus 1 comprises a trolley 2 (an example of a frame body) provided with a pair of roller members 3, a pair of guide rails 4 on which the roller members 3 travel, cables 5 for connecting various devices associated with operation of the conveyor apparatus 1, and a support frame 6 (an example of a support member) having a support surface 6a to support the cables 5. Further, the conveyor apparatus 1 is provided with a guide member 24. The guide member 24 comes into contact with a pair of side wall portions (a side wall portion 41b and a side wall portion 42b) of the pair of guide rails 4, thereby assisting smooth traveling of the trolley 2 along the guide rails 4 and preventing the trolley 2 from dropping. Further, the conveyor apparatus 1 is provided with a motor 7 (an example of an actuator) for generating a driving force as a driving source for rolling the pair of roller members 3 on the guide rails 4, a friction roller 8 (an example of a transmission mechanism) for transmitting the driving force applied by the motor 7 to the frame body and a control unit 9 in which a control system for performing various controls of the conveyor apparatus 1 is stored. Configurations of the respective components are described below.

### Trolley 2

The trolley 2 (an example of a frame body) is a member for rolling the roller members 3 by means of a driving force applied by the motor 7 to be described later. Further, the carriage P on which a body B of a car is placed and a roller abutting portion C to which a roller body 81 of the friction roller 8 to be described later is abutted are mounted on the trolley 2.

The carriage P (an example of a moving body) is a member for supporting a bottom surface of the body B (an example of an article to be transferred) of a car to convey the body B. A shape of the carriage P is not limited particularly. In this embodiment, the carriage P on which a plurality of rod-like members welded to each other are disposed in a lengthwise direction and a widthwise direction of the body B is illustrated. Support projections P1 for supporting the bottom surface of the body B are formed on the top surfaces of the rod-like members. Further, an extending portion P2 to be mounted on the trolley 2 is formed on the bottom surface of the rod-like member disposed in the lengthwise direction of the body B. Further, a rod-like fixture P3 on which a roller abutting portion is mounted is provided on the bottom surface of the extending portion P2. A shape of the fixture P3 is not limited particularly. In this embodiment, the fixture P3 on which a plurality of rod-like members welded to each other are disposed in a lengthwise direction and a widthwise direction of the body B is illustrated.

The roller abutting portion C is a member to which the roller body 81 of the friction roller 8 abuts. The roller abutting portion C is formed by jointing a plurality of rod-like members disposed in a lengthwise direction and a widthwise direction of the body B, and is also called a connecting rod (load bar). The roller body 81 is rotated by driving a motor 7 described later, thereby generating a friction force between the roller body 81 and the roller abutting portion C. The trolley 2 rotates the roller members 3 by the generated friction force, and as a result, the carriage P (and the body B) is conveyed along the conveyance path.

The trolley 2 comprises a pair of roller members 3, a roller mounting portion 21 which is formed below the roller abutting portion C and on which the pair of roller members 3 is mounted, and the guide member 24.

The roller mounting portion 21 is a portion where the pair of roller members 3 is mounted. More specifically, the roller mounting portion 21 comprises a plate-like top surface portion 22 on which the bottom end of the roller abutting portion C is mounted, and a pair of roller support pieces 23 extending downward at both ends of the top surface portion 22. The pair of roller members 3 disposed oppositely is rotatably mounted on the pair of roller support pieces 23. Further, the guide member 24 is mounted at the back side of the top surface portion 22. The guide member 24 comes into contact with the pair of side wall portions (a side wall portion 41b and a side wall portion 42b) of the pair of guide rails 4, thereby assisting smooth traveling of the trolley 2 along the guide rails 4 and preventing the trolley 2 from dropping.

### Roller Members 3

The roller members 3 are a pair of roller members rotating on the guide rails 4 for conveying the carriage P along the conveyance path. The respective roller members 3 are mounted inside the roller support pieces 23. A size of each of the roller members 3 is not limited particularly. The size of the roller member 3 may be appropriately selected to a weight, etc. of an article to be conveyed.

### Guide Rails 4

The guide rails 4 are a pair of rail portions on which the respective roller members 3 travel. More specifically the guide rails 4 comprise traveling portions (a traveling portion 41a and a traveling portion 42a) on which the roller members 3 travel and side wall portions (a side wall portion 42a and a side wall portion 42b) extending substantially in a vertical direction from the traveling portions and being disposed at an inner part of a travelling position of the roller members 3. The guide rail 4 may be one at least comprising portions corresponding to the traveling portion and the side wall portion, and a shape thereof is not limited as far as the guide rail 4 comprises those portions. The shape of the guide rail 4 may be such that a cross-sectional shape thereof in a direction crossing at a right angle to the conveyance path is substantially C-shaped, U-shaped, L-shaped or the like. When the guide rail has such a shape, the roller member 3 can travel on the guide rail (traveling portion). Further, a space for housing the cables 5 described later can be formed. Furthermore, the guide member 24 for allowing the trolley 2 to travel on the guide rails 4 properly can come into contact with the side wall portions properly. In this embodiment, the guide rails 4 having a substantially C-shaped cross-section are illustrated.

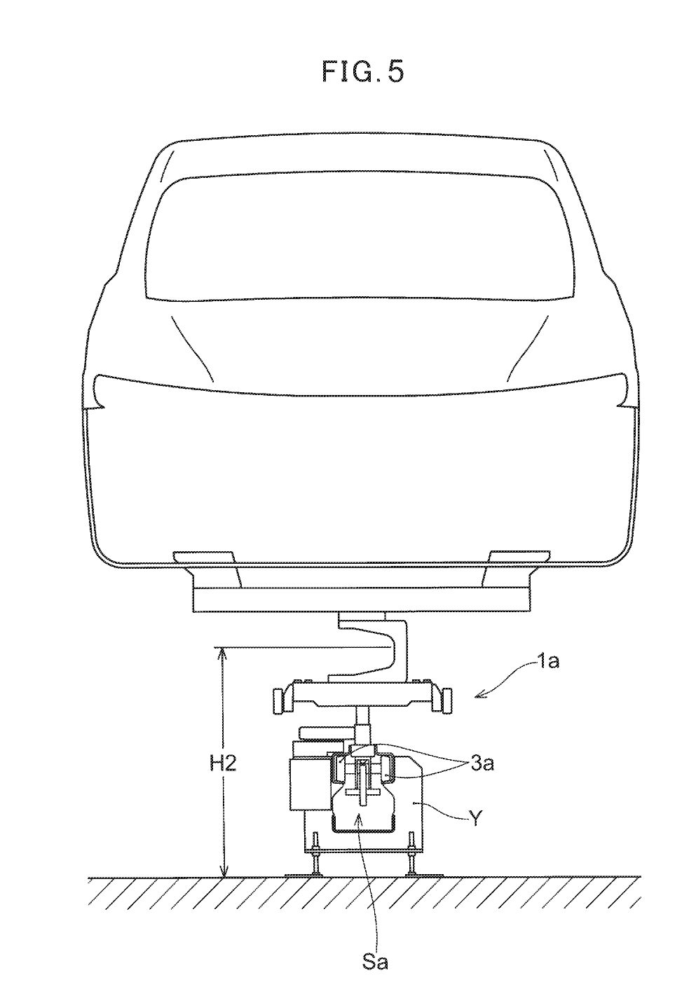

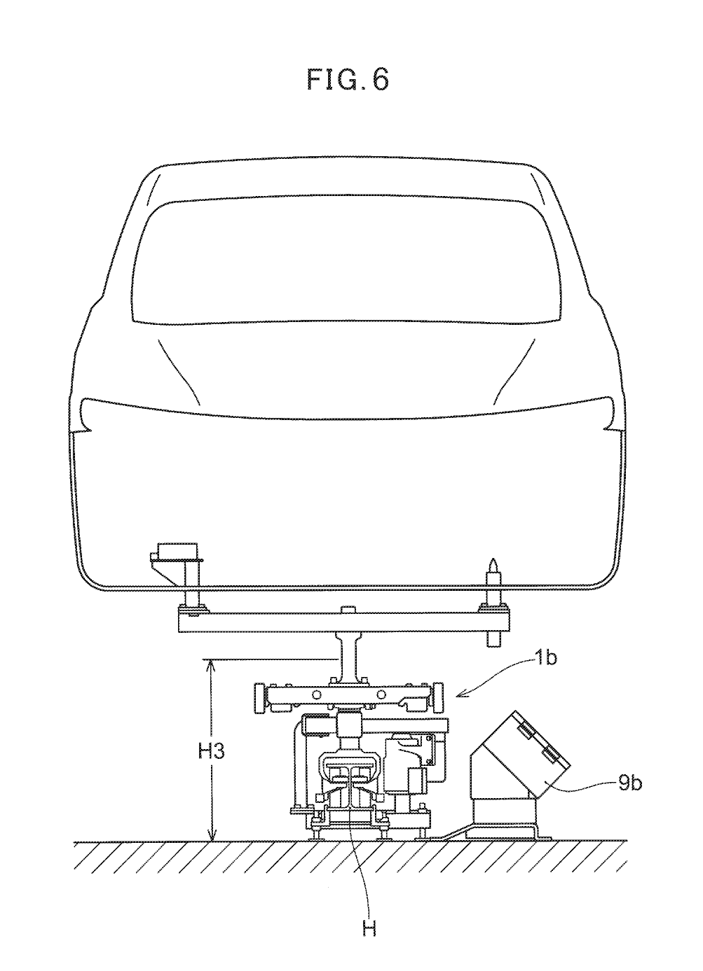

The guide rails 4 according to this embodiment are mounted on the support frame 6 described later, and are positioned appropriately. Therefore, a yoke which was essential for conventional conveyor apparatuses (see a yoke Y in FIG. 5) is not required. As a result, the number of components of the conveyor apparatus 1 is decreased, leading to cost saving. Further, weight saving of the conveyor apparatus 1 is easily achieved and a load to be applied to a building when installing the apparatus can be decreased appropriately. Further, since a yoke Y provided, for example, on a conventional conveyor apparatus 1a as shown in FIG. 5 is not necessary, a dimension in a height of the conveyor apparatus 1 can be designed so as to be decreased. In FIG. 1, the reference symbol H1 indicates an example of a height of a working platform when various works are conducted in the conveyor apparatus 1. The height H1 is designed so as to be lower than a height H2 (see FIG. 5) of a working platform in a conventional conveyor apparatus 1a and a height H3 (see FIG. 6) of a working platform in a conveyor apparatus 1b.

The conveyor apparatus 1 according to this embodiment is characterized in that in the pair of guide rails 4, the side wall portion (side wall portion 41b) of one guide rail (guide rail 41) and the side wall portion (side wall portion 42b) of the other guide rail (guide rail 42) are arranged separately from each other. Thus, the cables 5 described later can be housed in a space S defined by the support surface 6a of the support frame 6 described later, the side wall portion 41b and the side wall portion 42b. Further, when the pair of guide rails 4 are arranged separately from each other at a specified distance, a distance between the pair of roller members 3 is also kept relatively long. Further, the guide member 24 comes into contact with the side wall portions adequately, thereby assisting the traveling of the trolley 2. As a result, the conveyor apparatus 1 can convey the body B more stably.

Further, the pair of guide rails 4 is light in weight as compared with H steel beam (see steel beam H of FIG. 6) used on conventional conveyor apparatuses. Therefore, a weight of the conveyor apparatus 1 can be decreased, and a load to be applied to a building when installing the apparatus can be decreased accordingly.

In this embodiment, it is noted that “cables are housed in the space S” means that at least a part of the whole cables 5 is being housed in the space S, and the whole cables 5 need not be housed in the space S. Namely, since the cables 5 are cables for connecting the control unit 9 to the motor 7, etc. as described later, at least at the joints therewith, there exist cables which are not housed in the space S. However, in this embodiment, main portions of the cables 5 except cables for other portions can be housed in the space S. Therefore, in the conveyor apparatus 1 according to this embodiment, space saving can be achieved greatly as compared with the case of conventional conveyor apparatuses where cables are disposed outside the conveyor apparatuses (see FIG. 6).

### Cables 5

The cables 5 are members for connecting devices relating to operation of the conveyor apparatus 1. Kinds of the cables 5 are not limited particularly. Examples of the cables 5 include communication cables used for controlling a detector (not shown) provided on the control unit 9 described later, a power cable for connecting the control unit 9 to the motor 7 and the like. It is noted that in this embodiment, the cables 5 may include not only the cables 5 for connecting devices relating to operation of the conveyor apparatus 1 but also various pipes (air tubes and the like) which can be disposed around the conveyor apparatus 1.

### Support Frame 6

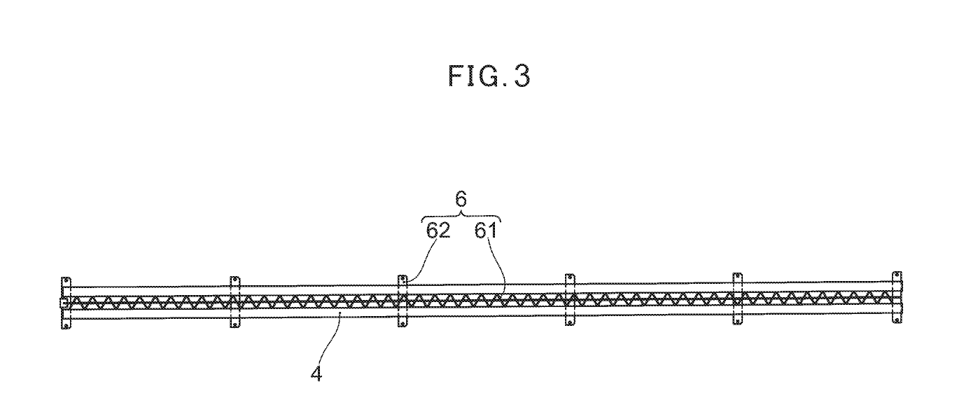

The support frame 6 (an example of a support member) is a member for supporting the cables 5 so that the cables 5 do not drop and sag downward. FIG. 3 is a schematic plan view of the support frame 6 according to this embodiment. The support frame 6 comprises a net-like body 61 disposed along the conveyance path and a plurality of net-like body supporting portions 62 disposed at a predetermined interval, and the net-like body 61 is laid on the net-like body supporting portions 62. The cables 5 are supported on a support surface 6a of the support frame 6 (the net-like body 61). Further, a partition member such as a shielding plate may be provided on the support surface 6a to allow the cables 5 to be separated appropriately. Also, as shown in FIG. 1, leg portions 63 may be provided on bottom surfaces of the net-like body supporting portions 62 for adjusting a height and a degree of levelness of the conveyor apparatus 1.

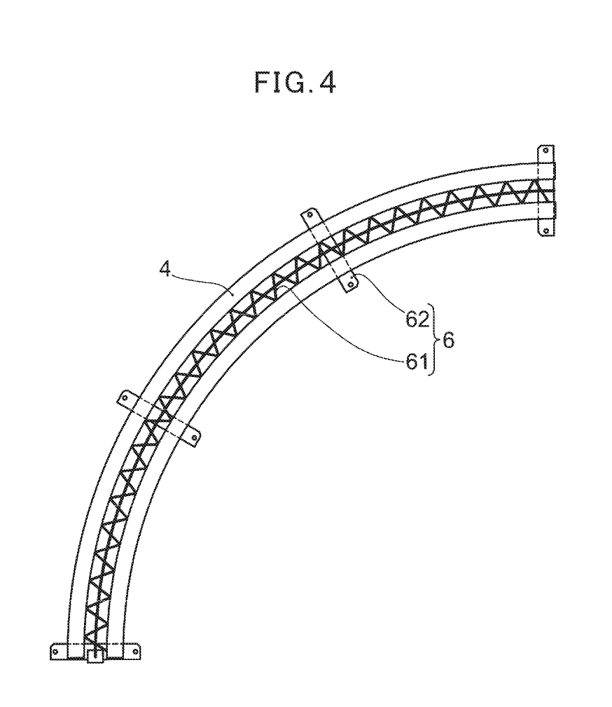

A shape of the net-like body 61 is not limited particularly. The net-like body 61 may be, for example, a waveform wire fabricated into a zigzag shape, a mesh wire formed by allowing a plurality of wires to cross each other or the like. In this embodiment, the net-like body 61 fabricated with a waveform wire is illustrated. FIG. 4 is a schematic plan view of the net-like body 61 disposed along curved guide rails 4. In the case where the net-like body 61 is a waveform wire, for example, even if the guide rails 4 are curved or bent, the net-like body 61 is easily deformed so as to follow the curving or the bending. As a result, the conveyor apparatus 1 can be arranged easily with the net-like body 61 being curved appropriately as compared with the case where a net-like body which is hardly deformed is used.

It is noted that in this embodiment, the support frame 6 may be a member being capable of preventing the cables 5 from dropping or sagging downward. For that purpose, for example, a flat metal plate (steel plate and the like) may be used as the support frame 6 in place of the net-like body 61.

### Motor 7

By referring to FIG. 1 and FIG. 2 again, the motor 7 (an example of an actuator) is a portion for generating a driving force as a driving source for rolling the pair of roller members 3. The motor 7 together with the friction roller 8 described below are mounted on the support frame 6 of the conveyor apparatus 1. The motor 7 is electrically connected to the control unit 9 described below by means of a power cable, and operation thereof is controlled by the control unit 9. Further, the motor 7 is connected to the friction roller 8, and the driving force generated by driving the motor 7 by means of the control unit 9 is transmitted to the friction roller 8 to rotate the roller body 81.

### Friction Roller 8

The friction roller 8 (an example of a transmission mechanism) is a member for transmitting the driving force applied by the motor 7 to the roller abutting portion C of the trolley 2. A plurality of friction rollers 8 may be provided at a predetermined interval along the conveyance path. It is noted that the friction roller 8 may not be disposed, for example, at a place where the conveyance of the trolley 2 can be performed manually.

The friction roller 8 comprises a body portion 82 on which the motor 7 is mounted, a roller shaft 83 connected to the body portion 82, the roller body 81 connected to the roller shaft 83 and an energizing mechanism (not shown) for energizing the roller body 81 so as to abut against the roller abutting portion C. The driving force generated by driving the motor 7 is transmitted to the roller shaft 83 to rotate the roller shaft 83, thereby rotating the roller body 81 toward a predetermined direction.

### Control Unit 9

The control unit 9 is a portion in which a control system for performing various controls of the conveyor apparatus 1 is stored. The control unit 9 is mounted on the support frame 6 of the conveyor apparatus 1 in the same manner as the motor 7 and the friction roller 8. A plurality of control units 9 may be disposed at a predetermined interval along the conveyance path.

To the control unit 9 are connected the cables 5 such as a power cable for controlling operation of the motor 7 and a communication cable for a detector (not shown).

As mentioned above, according to the conveyor apparatus 1 of this embodiment, the cables 5 can be housed in the space S defined by the support surface 6a and the side wall portions of the guide rails 4 (the side wall portion 41b and the side wall portion 42b). Therefore, the cables 5 can be disposed at a horizontal position equivalent to that of the roller members 3 traveling on the guide rails 4. As a result, the conveyor apparatus 1 can be designed such that a dimension in its height direction is low, and space saving is achieved. Further, the roller members 3 traveling on the guide rails 4 are visually recognized easily from the outside. Therefore, for example, a degree of wear of a traveling surface of the guide rail is easily confirmed. Further, cleaning of the roller members 3 is easy. Furthermore, in the conveyor apparatus 1, a member corresponding to a conventional yoke can be dispensed with. Thus, weight saving of the conveyor apparatus 1 is easily achieved and a load to be applied to a building when installing the apparatus can be decreased appropriately.

It is noted that in the present invention, for example, the following variances of embodiment may be employed.

(1) In the above-mentioned embodiment, the conveyor apparatus employing a friction system using a friction roller is illustrated. However, the conveyor apparatus of the present invention is featured by the structure of the guide rails and the support member, and may be one formed so as to be capable of housing the cables. Therefore, the conveyor apparatus of the present invention may be one employing a chain system in place of the friction system.

(2) In the above-mentioned embodiment, the case where the motor, the friction roller and the control unit are mounted on the support frame is illustrated. However, in the conveyor apparatus of the present invention, these components may be mounted on other place than the support frame. As an example, these components may be arranged around the conveyance path. Further, these components may be properly integrated to each other.

(3) In the above-mentioned embodiment, the conveyor apparatus provided with side wall portions extending from the traveling portion in a substantially vertical direction is illustrated. However, in place of such a configuration, the side wall portions of the conveyor apparatus of the present invention may be those having a shape being capable of defining a space enabling the cables to be housed. Therefore, the side wall portions may be extended from the traveling portion in an obliquely upward direction at a specified angle.

(4) In the above-mentioned embodiment, the case where an article to be conveyed is a car body is illustrated. In place of such configuration, an article to be conveyed by the conveyor apparatus of the present invention may be one other than the car body, and is not limited particularly.

One embodiment of the present invention is as mentioned above. The present invention is not limited specifically to the above-mentioned embodiment. It is noted that the above-mentioned embodiment mainly illustrates the inventions having the following configurations.

(1) A conveyor apparatus for conveying, along a specified conveyance path, a moving body on which an article to be transferred is placed, the conveyor apparatus comprising a pair of roller members that rolls along the conveyance path, a frame body to which the pair of roller members are attached, a pair of guide rails on which the roller members travel, cables for connecting various devices associated with operation of the conveyor apparatus, and a support member having a support surface to support the cables, wherein each of the guide rails comprises a traveling portion on which the roller member travels, and a side wall portion extending in a substantially vertical direction from the traveling portion and being disposed at an inner part of a travelling position of the roller member, wherein the side wall portion of one of the guide rails and the side wall portion of the other one of the guide rails are arranged separately from each other, and wherein the cables are housed in a space defined by the support surface and the respective side wall portions.

According to such configuration as mentioned above, the cables can be housed in the space defined by the support surface and the side wall portions of the guide rails. Therefore, the cables can be disposed at a horizontal position equivalent to that of the roller members traveling on the guide rails. As a result, the conveyor apparatus can be designed such that a dimension in its height direction is low, and space saving is achieved. Further, the roller members traveling on the guide rails are visually recognized easily from the outside. Therefore, for example, a degree of wear of a traveling surface of the guide rail is easily confirmed. Further, cleaning of the roller members is easy. Furthermore, in the conveyor apparatus, a member corresponding to a conventional yoke can be dispensed with. Thus, weight saving of the conveyor apparatus is easily achieved and a load to be applied to a building when installing the apparatus can be decreased appropriately.

(2) The conveyor apparatus of the above (1), further comprising an actuator for generating a driving force which is a driving source for rolling the pair of roller members on the guide rails and a transmission mechanism for transmitting the driving force generated by the actuator to the frame body, wherein the transmission mechanism has a driving roller rotatably driven by the actuator, and wherein the frame body has a roller abutting portion on which the driving roller abuts, and by allowing the driving roller to be rotatably driven by means of the driving force from the actuator, a friction force is generated between the drive roller and the roller abutting portion, thereby rolling the pair of roller members along the conveyance path.

According to such configuration as mentioned above, the frame body receives the driving force from an actuator to enable the roller members to be rotated on the guide rails. Power cables (an example of cables) essential for driving such an actuator and the like can be housed inside the conveyor apparatus of the present invention. Therefore, in the conveyor apparatus, not only space saving is achieved but also staining of the power cables and the like is prevented.

(3) The conveyor apparatus of the above (1) or (2), wherein the support member comprises a net-like body disposed along the conveyance path and a plurality of net-like body supporting portions disposed apart from each other, and the net-like body is laid on the net-like body supporting portions.

According to such configuration as mentioned above, the cables are supported by the net-like body along the conveyance path and hardly sags vertically downward. Therefore, appearance of the conveyor apparatus is good, and the cables are hardly stained.

(4) The conveyor apparatus of the above (3), wherein the net-like body is a waveform wire.

According to such configuration as mentioned above, for example, even if the guide rails are curved or bent, the net-like body is easily deformed so as to follow the curving or the bending of the guide rails. As a result, the conveyor apparatus can be arranged easily with the net-like body being curved appropriately as compared with the case where a net-like body which is hardly deformed is used.

### EXPLANATION OF SYMBOLS

1, 1a, 1b Conveyor apparatus
2 Trolley
21 Roller mounting portion
22 Top surface portion
23 Roller support piece
24 Guide member
3, 3a Roller members
4, 41, 42 Guide rails
41a, 42a Travelling portions
41b, 42b Side wall portions
5 Cables
6 Support frame
6a Support surface
61 Net-like body
62 Net-like body supporting portion
63 Leg portion
7 Motor
8 Friction roller
81 Roller body
82 Body portion
83 Roller shaft
9, 9b Control units
B Body
C Roller abutting portion
H Steel beam
H1, H2, H3 Height of working platform
P Carriage
P1 Support projection
P2 Extending portion
P3 Fixture
S, Sa Space
Y Yoke

1. A conveyor apparatus for conveying, along a specified conveyance path, a moving body on which an article to be transferred is placed, the conveyor apparatus comprising:
a frame body to which a pair of roller members that rolls along the conveyance path are attached,
a pair of guide rails on which the roller members travel,
cables for connecting various devices associated with operation of the conveyor apparatus, and
a support member having a support surface to support the cables, wherein each of the guide rails comprises:
a traveling portion on which one of the roller members travels, and
a side wall portion extending from the traveling portion and being disposed at an inner part of a travelling position of the roller member,
wherein the side wall portion of one of the guide rails and the side wall portion of the other one of the guide rails are arranged separately from each other, and
wherein the cables are housed in a space defined by the support surface and the respective side wall portions.

2. The conveyor apparatus of claim 1, further comprising an actuator for generating a driving force which is a driving source for rolling the pair of roller members on the guide rails and a transmission mechanism for transmitting the driving force generated by the actuator to the frame body,
wherein the transmission mechanism has a driving roller rotatably driven by the actuator, and
wherein the frame body has a roller abutting portion on which the driving roller abuts, and
by allowing the driving roller to be rotatably driven by means of the driving force from the actuator, a friction force is generated between the drive roller and the roller abutting portion, thereby rolling the pair of roller members along the conveyance path.

3. The conveyor apparatus of claim 1, wherein the support member comprises:
a net-like body disposed along the conveyance path, and
a plurality of net-like body supporting portions disposed apart from each other, and the net-like body is laid on the net-like body supporting portions.

4. The conveyor apparatus of claim 3, wherein the net-like body is a waveform wire.

5. The conveyor apparatus of claim 2, wherein the support member comprises:
a net-like body disposed along the conveyance path, and
a plurality of net-like body supporting portions disposed apart from each other, and the net-like body is laid on the net-like body supporting portions.

6. The conveyor apparatus of claim 5, wherein the net-like body is a waveform wire.
